(19) United States
(12) Patent Application Publication
(10) Pub. No.: US 2015/0243943 A1
(43) Pub. Date: Aug. 27, 2015

(54) Energy Storage Device

(71) Applicant: GS Yuasa International Ltd., Kyoto-shi (JP)

(72) Inventor: Hideki MASUDA, Kyoto-shi (JP)

(21) Appl. No.: 14/602,183

(22) Filed: Jan. 21, 2015

(30) Foreign Application Priority Data
Feb. 26, 2014 (JP) 2014-035012

(51) Int. Cl. H01M 2/08; H01M 2/30; H01M 10/42

(52) U.S. Cl. CPC H01M 2/08; H01M 10/425; H01M 2/30

(57) ABSTRACT

An energy storage device, including: an outer package having a first hole formed therein; a terminal passing through the outer package though the first hole; a sealing member in contact with an inner peripheral face of the first hole; a circuit board provided inside the outer package; and a heat conductive portion provided inside the outer package to connect the circuit board and the terminal.

### CROSS-REFERENCE TO RELATED APPLICATIONS

This application claims the benefit of Japanese patent application No. 2014-035012, filed on Feb. 26, 2014, which is incorporated by reference.

### FIELD

The present invention relates to an energy storage device and particularly to an energy storage device having a circuit board built-in.

### BACKGROUND

In an energy storage apparatus having an energy storage device, a circuit board is provided so as to prevent overcharge and overdischarge.

JP-A-2000-149918 discloses a secondary battery including a battery case having an opening portion, a sealing plate having an electronic circuit arranged thereon, and a gasket provided between the opening portion and the sealing plate.

### SUMMARY

The following presents a simplified summary of the invention disclosed herein in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In the secondary battery described in JP-A-2000-149918, the gasket may be deteriorated by heat generated from the electronic circuit, because the heat is conducted to the gasket through the sealing plate. For this reason, the airtightness of the battery may be reduced.

The present invention has been made in view of the above problem and it is an object of the present invention to provide an energy storage device in which reduction in airtightness of the energy storage device can be suppressed.

An aspect of the present invention provides an energy storage device including: an outer package having a first hole formed therein; a terminal passing through the outer package though the first hole; a sealing member in contact with an inner peripheral face of the first hole; a circuit board provided inside the outer package; and a heat conductive portion provided inside the outer package to connect the circuit board and the terminal. Airtightness of the energy storage device may be kept by the sealing member of the outer package so as to prevent an electrolyte solution from leaking.

### BRIEF DESCRIPTION OF THE DRAWINGS

The foregoing and other features of the present invention will become apparent from the following description and drawings of an illustrative embodiment of the invention in which:

FIG. 1 shows an exploded perspective view of a battery according to a first embodiment of the present invention;

FIG. 2 shows a sectional view taken in direction Z along line 500-500 in FIG. 1;

FIG. 3 shows a view of an inner face side of a lid portion of the battery according to the first embodiment;

FIG. 4 shows a schematic sectional view of an inner structure of an upper portion of a battery according to a second embodiment of the present invention;

FIG. 5 shows a schematic sectional view of an inner structure of an upper portion of a battery according to a first variation of the first embodiment; and

FIG. 6 shows a schematic sectional view of an inner structure of an upper portion of a battery according to a second variation of the first embodiment.

### DESCRIPTION OF EMBODIMENTS

An energy storage device according to an aspect of the present invention includes: an outer package having a first hole formed therein; a terminal passing through the outer package though the first hole; a sealing member in contact with an inner peripheral face of the first hole; a circuit board provided inside the outer package; and a heat conductive portion provided inside the outer package to connect the circuit board and the terminal. Airtightness of the energy storage device may be kept by the sealing member of the outer package so as to prevent an electrolyte solution from leaking.

In the energy storage device according to the aspect, the circuit board is disposed inside the outer package and the circuit board and the terminal are connected to each other by the heat conductive portion. Thereby, it is possible to dissipate heat generated from the circuit board to the terminal through the heat conductive portion. In this way, conduction of the heat to the sealing member can be suppressed, and thus it is possible to suppress deterioration of the sealing member due to the heat generated from the circuit board. As a result, reduction in the airtightness of the energy storage device can be reduced.

In the energy storage device, the terminal preferably has a swaged portion. With this configuration, the effect obtained by dissipating the heat generated from the circuit board to the terminal through the heat conductive portion relatively increases.

In this case, the swaged portion preferably fixes the heat conductive portion. With this configuration, the swaged portion of the terminal can maintain a state in which the terminal and the heat conductive portion are in close contact with each other, and thus the heat generated from the circuit board can be dissipated further efficiently by the terminal through the heat conductive portion.

In the energy storage device, a negative electrode terminal is preferably formed of copper and the circuit board and the negative electrode terminal are connected to each other by the heat conductive portion. With this configuration, it is possible to efficiently dissipate the heat generated from the circuit board to the negative electrode terminal formed of copper having good heat conductivity. Further, when the energy storage device is applied to a high-voltage battery such as a lithium ion battery, it is possible to make a negative electrode terminal less liable to corrode by using copper.

In the energy storage device, each of the outer package and the heat conductive portion preferably includes metal and an insulating member is preferably provided between the outer package and the heat conductive portion. With this configuration, even when the heat conductive portion including metal is coupled to a power generating element that generates electric power, it is possible to suppress conduction of the heat generated from the circuit board to the sealing member while preventing a flow of electricity to the outer package through the heat conductive portion.

According to the aspects, it is possible to suppress reduction in the airtightness of the energy storage device as described above.

Embodiments of the present invention will be described hereinafter based on the drawings.

### First Embodiment

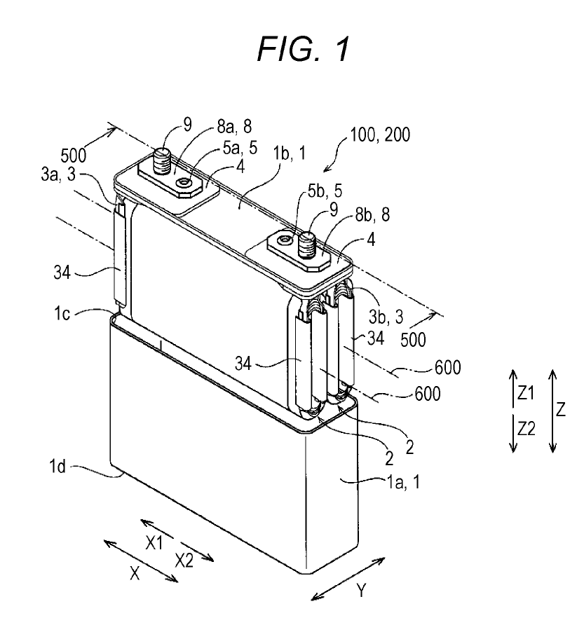

First, with reference to FIGS. 1 to 3, a configuration of a battery 100 according to a first embodiment of the present invention will be described. Note that the battery 100 is an example of an “energy storage device”.

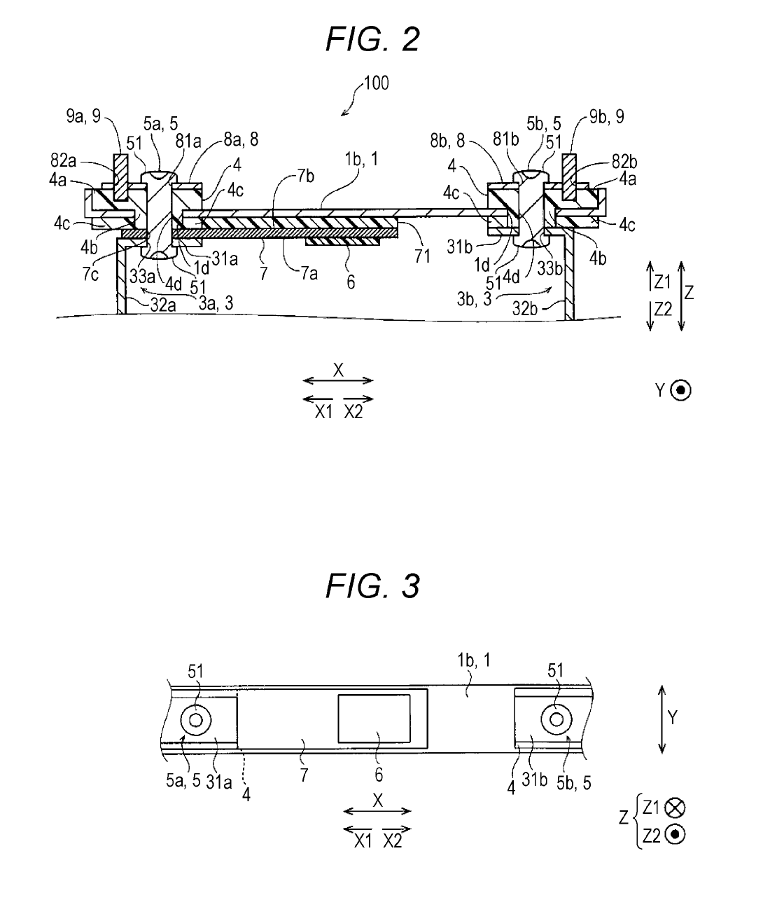

The battery 100 is a lithium ion battery. The battery 100 includes, as shown in FIG. 1, a battery case 1 having a case portion 1a and a lid portion 1b, and power generating elements 2 housed in the battery case 1. Moreover, the battery 100 includes current collectors 3 connected to the power generating elements 2, respectively, sealing members 4 provided in the lid portion 1b, rivets 5, a circuit board 6 housed inside the battery case 1 (see FIG. 2), and a heat conductive plate 7 (see FIG. 2). The battery 100 includes connecting bars 8 and connecting terminals 9. Each of the connecting bars 8 connects the rivets 5 and the connecting terminals 9, respectively. Note that the lid portion 1b and the battery case 1 are an example of an “outer package”. Each of the rivets 5 is an example of a “terminal”.

The battery case 1 is made of stainless steel (SUS material), for example. Note that, as the battery case 1, a battery case made of a nickel-plated iron material or an iron alloy other than stainless steel may be used.

The case portion 1a has an opening portion 1c at an upper part (on a side in direction Z1) and a bottom portion 1d at a lower part (on a side in direction Z2). The case portion 1a substantially has a shape of a rectangular parallelepiped box. A nonaqueous electrolyte solution (hereafter referred to as an “electrolyte solution”) (not shown) prepared by dissolving an electrolyte salt in a nonaqueous solvent is poured in the battery case 1.

The lid portion 1b is configured to be fitted in the opening portion 1c of the case portion 1a. In a state in which the power generating elements 2 and the electrolyte solution are housed in the case portion 1a, the opening portion 1c of the case portion 1a and the lid portion 1b are welded together and sealed by laser welding. On each of opposite sides in direction X of the lid portion 1b, a hole portion 1d in which each of the sealing members 4 and each of the rivets 5 (each of a negative rivet 5a and a positive rivet 5b described later) are disposed is formed. Note that the hole portion 1d is an example of a “first hole”.

Each of the power generating elements 2 is configured by winding metal foil, on which an active material is applied, around a winding axis 600 extending in direction X. The two power generating elements 2 are aligned and disposed along direction Y.

The current collectors 3 include a negative current collector 3a electrically connected to one end (an end on a side in direction X1) in direction X of one of the power generating elements 2 and a positive current collector 3b electrically connected to the other end (end on a side in direction X2) in direction X. The negative current collector 3a includes a plate-shaped member made of copper. The positive current collector 3b includes a plate-shaped member made of aluminum. The negative current collector 3a and the positive current collector 3b are each formed in a substantially angular shape when seen in direction Y as shown in FIG. 2. Specifically, the negative current collector 3a and the positive current collector 3b are each formed in a substantially L shape when seen in direction Y. The negative current collector 3a and the positive current collector 3b have contact portions 31a and 31b and current collector portions 32a and 32b, respectively. The contact portions 31a and 31b include hole portions 33a and 33b through which the rivets 5 pass, respectively. Each of the contact portions 31a and 31b is formed so as to have a flat face on a side of the lid portion 1b (on the side in direction Z1). As shown in FIG. 1, the current collector portion 32a of the negative current collector 3a and the current collector portion 32b of the positive current collector 3b and end portions of the power generating elements 2 are fixed by being sandwiched by holding members 34, respectively. Note that, in FIG. 2, the holding members 34 are not shown.

In the first embodiment, each of the sealing members 4 has a function of suppressing leakage of the electrolyte solution in the battery 100 to the outside from the lid portion 1b. Each of the sealing members 4 is compressed between the lid portion 1b and each of the rivets 5 and elasticity against the compression suppresses the leakage of the electrolyte solution to the outside. As shown in FIG. 2, each of the sealing members 4 has a substantially rectangular section when seen in direction Y. Specifically, each of the sealing members 4 is formed by a gasket made by an upper portion 4a and an intermediate portion 4b and a separate gasket made by a lower portion 4c. Each of the sealing members 4 is formed in a substantially H shape when seen in direction Y. Moreover, each of the sealing members 4 includes a hole portion 4d extending in direction Z. Note that the hole portion 4d is an example of a “second hole”. The upper portion 4a and the lower portion 4c are each larger in the width in direction X than the intermediate portion 4b.

Each of the sealing members 4 is provided between the lid portion 1b of the battery case 1 and each of the rivets 5. Specifically, each of the sealing members 4 is in contact with an inner peripheral face of the hole portion 1d in the lid portion 1b. Each of the sealing members 4 is fitted in the hole portion 1d in the lid portion 1b with the intermediate portion 4b in close contact with the hole portion 1d and, in this position, the upper portion 4a and the lower portion 4c are sandwiched from above and below, respectively. The intermediate portion 4b of each of the sealing members 4 is compressed by increase in diameter of a central portion of each of the rivets 5 when each of the rivets 5 is swaged. Each of the sealing members 4 is formed of PPS (Poly Phenylene Sulfide).

In the first embodiment, the rivets 5 include the negative rivet 5a provided on a negative side and the positive rivet 5b provided on a positive side. The negative rivet 5a has an upper end portion (on the side in direction Z1) and a lower end portion (on the side in direction Z2) which are swaged to form swaged portions 51 in a state in which the negative rivet is inserted into the hole portion 4d in one of the sealing members 4 on the side in direction X1. The end portions of the rivet 5a are each larger in size than the hole portion 4d in a direction perpendicular to a thickness direction (direction Z) of the lid portion 1b. In this way, the swaged portions 51 are configured to fasten the contact portion 31a of the negative current collector 3a, the heat conductive plate 7, one of the sealing members 4, and one of the connecting bars 8 (a negative connecting bar 8a described later) together in a state of being in close contact with each other. In a similar manner to the negative rivet 5a, an upper end portion and a lower end portion of the positive rivet 5b are swaged in a state in which the positive rivet is inserted into the hole portion 4d in one of the sealing members 4 on the side of direction X2 to form swaged portions 51. The end portions of the rivet 5b are each larger in size than the hole portion 4d in the direction perpendicular to the thickness direction (direction Z) of the lid portion 1b. In this way, the swaged portions 51 are configured to fasten the contact portion 31b of the positive current collector 3b, one of the sealing members 4, and one of the connecting bars 8 (a positive connecting bar 8b described later) together in a state of being in close contact with each other. In swaging, the diameter of the central portion in direction Z of each of the rivets 5 increases toward an outer peripheral side to compress the intermediate portion 4b of each of the sealing members 4. The negative rivet 5a and the positive rivet 5b are each configured so that the end portion on the side in direction Z1 is exposed outside the battery case 1. The negative rivet 5a is an example of a “terminal” and a “negative electrode terminal”. This configuration is preferable because each of the rivets 5 is formed to protrude in a direction (direction Z) intersecting a face of the lid portion 1b and in this way the rivets 5 can efficiently dissipate heat generated from the circuit board 6.

The circuit board 6 has a function of carrying out control related to operation such as adjustment of voltage in charge and discharge of the battery 100 and a function of outputting a state of the battery 100 to an external device. The circuit board 6 is provided inside the case 1 (on a lower face 7a on the side in direction Z2 of the heat conductive plate 7). Note that the circuit board 6 has a surface treated with a film so as not to be corroded by the electrolyte solution in the battery case 1.

In the first embodiment, the heat conductive plate 7 is made of metal such as aluminum and formed in a flat plate shape. The heat conductive plate 7 has a substantially rectangular shape (see FIG. 3) in a plan view. The heat conductive plate 7 is configured so that the end portion on the side in direction X1 extends to a position of the current collector portion 32a. Near the end portion on the side in direction X1 of the heat conductive plate 7, a hole portion 7c extending in direction Z is formed. Substantially the entire upper face (face on the side in direction Z1) of the contact portion 31a of the negative current collector 3a is configured to come in contact (close contact) with the lower face 7a of the heat conductive plate 7. The heat conductive plate 7 is configured so that the end portion on the side in direction X2 extends to a substantially central position in direction X of the battery 100. On the lower face 7a near the end portion on the side in direction X2 of the heat conductive plate 7, the circuit board 6 is attached.

The circuit board 6 and the negative rivet 5a are connected to each other through the heat conductive plate 7. As shown in FIG. 3, the heat conductive plate 7 is configured so that the circuit board 6 does not protrude from the heat conductive plate 7 in the plan view. As shown in FIG. 2, an insulating member 71 is disposed on an upper face 7b of the heat conductive plate 7. The insulating member 71 is sandwiched between the upper face 7b of the heat conductive plate 7 and an inner surface (a face on the side in direction Z2) of the lid portion 1b. In other words, the heat conductive plate 7 is disposed on the inner surface of the lid portion 1b with the insulating member 71 interposed therebetween. The insulating member 71 is formed of polyimide or the like. Note that the heat conductive plate 7 is an example of a “heat conductive portion”.

Each of the connecting bars 8 is disposed on an upper face (a face on the side in direction Z1) of each of the sealing members 4 and has a function of electrically connecting each of the rivets 5 and each of the connecting terminals 9. Each of the connecting bars 8 is formed in a plate shape. The connecting bars 8 include the negative connecting bar 8a and the positive connecting bar 8b. The negative connecting bar 8a (positive connecting bar 8b) includes a hole portion 81a (81b) through which one of the rivets 5 passes and a hole portion 82a (82b) through which one of the connecting terminals 9 passes.

Each of the connecting terminals 9 has a threaded outer peripheral face and is formed in a substantially columnar shape. The connecting terminals 9 include a negative connecting terminal 9a and a positive connecting terminal 9b. The negative connecting terminal 9a and the positive connecting terminal 9b are configured to be fitted in the sealing members 4 by screwing through the hole portions 82a and 82b in the negative connecting bar 8a and the positive connecting bar 8b, respectively.

The negative connecting terminal 9a, the negative rivet 5a, and the negative connecting bar 8a each include copper in a similar manner to the negative current collector 3a. The positive connecting terminal 9b, the positive rivet 5b, and the positive connecting bar 8b each include aluminum in a similar manner to the positive current collector 3b.

With the first embodiment, it is possible to obtain the following effects.

In the first embodiment, as described above, the circuit board 6 is provided inside the case 1 and the circuit board 6 and the negative rivet 5a are connected to each other by the heat conductive plate 7. In this way, it is possible to dissipate the heat generated from the circuit board 6 to the negative rivet 5a exposed outside the battery case 1 through the heat conductive plate 7. As a result, the heat can be conducted to the negative rivet 5a through the heat conductive plate 7 while conduction of the heat to the sealing members 4 through the lid portion 1b can be reduced, and thus deterioration of the compressed sealing members 4 can be suppressed. Therefore, it is possible to suppress reduction in airtightness of the battery 100. When the circuit board 6 is provided inside the case 1, the heat generated from the circuit board can be conducted to the negative rivet 5a through the heat conductive plate 7 and dissipated outside the battery case 1.

In the first embodiment, as described above, the negative rivet 5a has the swaged potions. In this way, even when the intermediate portion 4b of each of the sealing members 4 is compressed by the swaged portions 51 of each of the rivets 5 and liable to become deteriorated, it is possible to dissipate heat generated from the circuit board 6 to the rivets 5 through the heat conductive plate 7 and transfer of the heat to the intermediate portion 4b of each of the sealing members 4 can be reduced. Specifically, the intermediate portion 4b of each of the sealing members 4 is compressed by the increase in the diameter of the central portion of each of the rivets 5 and thus, when the heat conductive plate 7 (heat conductive portion) does not exist, the deterioration of the intermediate portion 4b of each of the sealing members 4 due to the heat conducted from the lid portion 1b is facilitated. Accordingly, the effect obtained by dissipating the heat generated from the circuit board 6 to the rivets 5 through the heat conductive plate 7 relatively increases.

In the first embodiment, as described above, the heat conductive plate 7 is fixed by the swaged portions. In this way, the swaged portions of the negative rivet 5a can maintain the state in which the negative rivet 5a and the heat conductive plate 7 are in close contact with each other, and thus it is possible to further efficiently dissipate the heat generated from the circuit board 6 to the negative rivet 5a through the heat conductive plate 7.

In the first embodiment, as described above, the negative rivet 5a is formed of copper and the circuit board 6 and the negative rivet 5a are connected to each other by the heat conductive plate 7. In this way, it is possible to efficiently dissipate the heat generated from the circuit board 6 to the negative rivet 5a formed of copper having good heat conductivity.

In the first embodiment, as described above, the lid portion 1b and the heat conductive plate 7 each include metal and the insulating member 71 is provided between the lid portion 1b and the heat conductive plate 7. In this way, even when the heat conductive plate 7 including metal is coupled to the power generating elements 2, it is possible to suppress conduction of the heat generated from the circuit board 6 to the sealing members 4 while preventing a flow of electricity to the lid portion 1b through the heat conductive plate 7.

### Second Embodiment

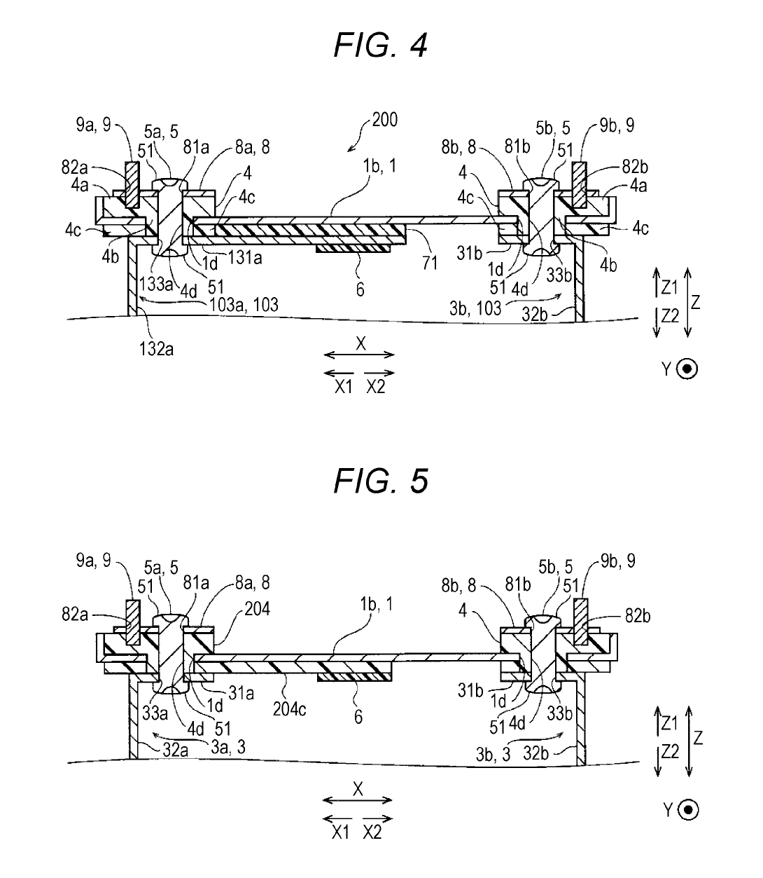

Next, with reference to FIGS. 1 and 4, a configuration of a battery 200 according to a second embodiment of the present invention will be described. The battery 200 is an example of the “energy storage device”.

In the second embodiment, unlike in the first embodiment in which the heat conductive plate 7 as the heat conductive portion is provided, the battery 200 in which a negative current collector 103a includes a heat conductive portion will be described. Note that, in the second embodiment, similar configurations to those in the first embodiment will be denoted by the same reference signs and the description thereof will be omitted.

As shown in FIG. 4, current collectors 103 of the battery 200 according to the second embodiment include a negative current collector 103a electrically connected to one end (an end on a side in direction X1) in direction X of one of power generating elements 2 (see FIG. 1) and a positive current collector 3b electrically connected to the other end (an end on a side in direction X2) in direction X.

The negative current collector 103a has a contact portion 131a and a current collector portion 132a. The contact portion 131a includes a hole portion 133a through which a negative rivet 5a passes. The contact portion 131a is formed so as to have a flat face on a side of a lid portion 1b (on a side in direction Z1). Note that the contact portion 131a is an example of the “heat conductive portion”.

In the second embodiment, the contact portion 131a is configured so that the end portion on the side in direction X2 extends to a substantially central position in direction X of the battery 200. On a lower face (a face on a side in direction Z2) near the end portion on the side in direction X2 of the contact portion 131a, a circuit board 6 is attached. In this way, the circuit board 6 and the negative rivet 5a are connected to each other through the contact portion 131a. That is, in the second embodiment, the contact portion 131a functions as the heat conductive portion. In this way, unlike in the case in which a dedicated member having the function as the heat conductive portion is provided, the number of parts can be reduced and the structure can be simplified. An insulating member 71 is disposed on an upper face (a face on the side in direction Z1) of the contact portion 131a. The insulating member 71 is sandwiched between the upper face of the contact portion 131a and an inner surface (a face on the side in direction Z2) of the lid portion 1b. In other words, the contact portion 131a is disposed on the inner surface of the lid portion 1b with the insulating member 71 interposed therebetween.

In the second embodiment, the negative rivet 5a has an upper end portion (on the side in direction Z1) and a lower end portion (on the side in direction Z2) which are swaged to form swaged portions 51. In this way, the swaged portions 51 are configured to fasten the contact portion 131a of the negative current collector 103a, one of sealing members 4, and a negative connecting bar 8a together in a state of being in close contact with each other.

Note that other configurations in the second embodiment are similar to those in the first embodiment described above.

With the second embodiment, it is possible to obtain the following effects.

In the second embodiment, as described above, the circuit board 6 is provided inside a case 1 and the circuit board 6 and the negative rivet 5a are connected to each other by the contact portion 131a of the negative current collector 103a. In this way, it is possible to suppress reduction in airtightness of the battery 200 in a similar manner to the first embodiment.

Note that other effects of the second embodiment are similar to those of the first embodiment.

Note that the embodiments disclosed herein are examples in all respects and should not be considered restrictive. The scope of the present invention is not defined by the above description of the embodiments but by the claims, and further includes meanings equivalent to the claims and all modifications in the scope of claims.

For example, although the first embodiment shows the example in which the plate-shaped heat conductive plate (heat conductive portion) is provided and the second embodiment shows the example in which the negative current collector is configured to include the contact portion functioning as the heat conductive portion, the present invention is not limited to thereto. As in a first variation shown in FIG. 5, a sealing member 204 configured to have a function of a heat conductive portion may be provided by extending an end portion on a side in direction X2 of a lower portion 204c of the sealing member 204 to a substantially central position in direction X of an energy storage device. In other words, the lower portion 204c of the sealing member 204 is disposed on an inner surface of a lid portion 1b. In this case, the sealing member 204 preferably includes a resin having an insulation property and high heat conductivity. Note that the lower portion 204c is an example of the “heat conductive portion”.

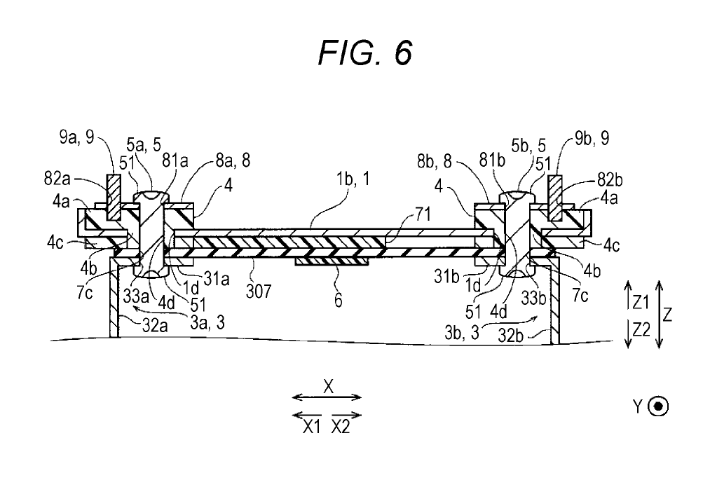

Although the battery (energy storage device) in which the heat generated from the circuit board is dissipated to the negative rivet (negative electrode terminal) through the heat conductive portion is shown in each of the first and second embodiments, the present invention is not limited thereto. The heat generated from the circuit board may be dissipated to the positive electrode terminal through the heat conductive portion. The heat generated from the circuit board may be dissipated to both of the negative electrode terminal and the positive electrode terminal. In this case, as in a second variation shown in FIG. 6, for example, heat generated from a circuit board can be dissipated to both of a negative rivet 5a (negative electrode terminal) and a positive rivet 5b (positive electrode terminal) by providing a heat conductive portion 307 which is an insulating body connecting the negative rivet 5a and the positive rivet 5b. In this way, it is possible to further efficiently dissipate the heat generated from the circuit board. Although each of the first and second embodiments shows the mode in which the rivets as an example of the terminal are connected to the connecting terminals through the connecting bars, respectively, a terminal may be configured by integrally forming all of a rivet, a connecting bar, a connecting terminal by using the same material. In this case, it is possible to dissipate heat generated from a circuit board to the outside of an outer package through a heat conductive portion and the terminal. It is also possible to provide a circuit board on an upper face of a heat conductive plate or an upper face of a contact portion of a current collector.

Although the present invention is applied to the lithium ion battery (energy storage device) in each of the first and second embodiments, the present invention is not limited thereto. The present invention may be applied to nonaqueous electrolyte batteries other than the lithium ion battery or may be applied to aqueous electrolyte batteries such as a nickel-metal hydride battery.

Although each of the first and second embodiments shows the example in which the sealing member is formed of PPS, the present invention is not limited thereto. A sealing member may be formed of a resin other than PPS, e.g., a resin such as PP (polypropylene) and PEEK (polyetheretherketone). Moreover, the sealing member may be formed of materials other than a resin, e.g., rubber such as EPDM (ethylene propylene diene methylene linkage).

What is claimed is:

1. An energy storage device, comprising:
an outer package having a first hole formed therein;
a terminal passing through the outer package though the first hole;
a sealing member in contact with an inner peripheral face of the first hole;
a circuit board provided inside the outer package; and
a heat conductive portion provided inside the outer package to connect the circuit board and the terminal.

2. The energy storage device according to claim 1, wherein the circuit board is disposed on a surface of the heat conductive portion.

3. The energy storage device according to claim 1, wherein the terminal includes a first end portion exposed outside the outer package and a second end portion disposed inside the outer package.

4. The energy storage device according to claim 3,
wherein the terminal passes through a second hole provided in the sealing member, and
the first end portion and the second end portion are each larger in size than the second hole in a direction perpendicular to a thickness of the outer package.

5. The energy storage device according to claim 1, wherein the terminal includes a swaged portion.

6. The energy storage device according to claim 5, wherein the swaged portion fixes the heat conductive portion.

7. The energy storage device according to claim 3, wherein the heat conductive portion connects the circuit board and the second end portion.

8. The energy storage device according to claim 1,
wherein a negative electrode terminal is formed of copper, and
the circuit board and the negative electrode terminal are connected to each other by the heat conductive portion.

9. The energy storage device according to claim 1,
wherein each of the outer package and the heat conductive portion comprises metal, and
an insulating member is provided between the outer package and the heat conductive portion.

10. The energy storage device according to claim 9, wherein the heat conductive portion is disposed on an inner surface of the outer package with the insulating member interposed therebetween.

11. The energy storage device according to claim 1, wherein the heat conductive portion is disposed on an inner surface of the outer package.
